(19) United States
(12) Patent Application Publication
(10) Pub. No.: US 2021/0408634 A1
(43) Pub. Date: Dec. 30, 2021

(54) BATTERY PACK VENTILATION ASSEMBLY AND SYSTEM FOR ELECTRIFIED VEHICLES

(71) Applicant: Ford Global Technologies, LLC, Dearborn, MI (US)

(72) Inventors: Bin Yin, Nanjing (CN); Steven Shi, Nanjing (CN); Tim Cui, Nanjing (CN)

(21) Appl. No.: 17/324,275

(22) Filed: May 19, 2021

(30) Foreign Application Priority Data
Jun. 30, 2020 (CN) 2020106142196

(51) Int. Cl. H01M 50/342

(52) U.S. Cl. CPC H01M 50/3425; H01M 2220/20

(57) ABSTRACT

A ventilation assembly for a battery pack according to an exemplary aspect of the present disclosure includes, among other things, a housing, a plurality of battery cells arranged in the housing, and a first isolation layer and a second isolation layer at least partially spaced-apart from one another and arranged in the housing. The first isolation layer is closer to the housing than the second isolation layer, and the second isolation layer at least includes a weakened area configured to at least partially separate from a remainder of the second isolation layer under a first predetermined pressure.

### RELATED APPLICATIONS

This application claims priority to Chinese Patent Application No. 2020106142196, filed Jun. 30, 2020, the entirety of which is herein incorporated by reference.

### TECHNICAL FIELD

This disclosure relates to a battery pack ventilation assembly and system for electrified vehicles.

### BACKGROUND

Electrified vehicles have developed rapidly due to their advantages in reducing fuel consumption and exhaust emissions. A typical electrified vehicle includes battery packs that can provide driving power. The battery pack includes one or more battery modules composed of one or more battery cells.

In some cases, such as when over-temperature, over-current, squeezing, etc., occurs, by-products of ventilation may be generated inside the battery and need to be exhausted from the battery cell. CN105280981 provides a battery pack ventilation system. The system includes an enclosure for establishing a ventilating chamber and a pipe communicating with the ventilating chamber. A check valve is installed on the housing and allows the by-products of battery ventilation to flow in a first direction but prevents air from flowing in a second direction opposite to the first direction.

### SUMMARY

A ventilation assembly for a battery pack according to an exemplary aspect of the present disclosure includes, among other things, a housing, a plurality of battery cells arranged in the housing, and a first isolation layer and a second isolation layer at least partially spaced-apart from one another and arranged in the housing. The first isolation layer is closer to the housing than the second isolation layer, and the second isolation layer at least includes a weakened area configured to at least partially separate from a remainder of the second isolation layer under a first predetermined pressure.

In a further non-limiting embodiment of the foregoing ventilation assembly, the first isolation layer includes a first body portion, the second isolation layer includes a second body portion, the first body portion and the second body portion are connected to each other by a connecting component to form a connection area, and areas other than the connection area in the first body portion and the second body portion are spaced apart by a first gap.

In a further non-limiting embodiment of any of the foregoing ventilation assemblies, the weakened area and the connection area are offset from each other.

In a further non-limiting embodiment of any of the foregoing ventilation assemblies, the connecting component is formed integrally with at least one of the first body portion and the second body portion, and connected to the other of the first body portion and the second body portion by one or more of welding, bonding, and a fastener.

In a further non-limiting embodiment of any of the foregoing ventilation assemblies, the housing includes a predetermined fluid channel and a battery pack vent valve in communication with both the predetermined fluid channel and an area outside the housing. Further, the first gap is in communication with the predetermined fluid channel.

In a further non-limiting embodiment of any of the foregoing ventilation assemblies, the battery cell includes a cell exhaust valve, and the weakened area is configured to correspond to the cell exhaust valve of the battery cell.

In a further non-limiting embodiment of any of the foregoing ventilation assemblies, the shortest distance between the second isolation layer and the cell exhaust valve is greater than the first gap.

In a further non-limiting embodiment of any of the foregoing ventilation assemblies, the weakened area includes one of a thinned area and a notched area.

In a further non-limiting embodiment of any of the foregoing ventilation assemblies, the weakened area is continuous or discontinuous.

In a further non-limiting embodiment of any of the foregoing ventilation assemblies, the first isolation layer has a thickness greater than that of the second isolation layer, and both the first isolation layer and the second isolation layer are made of flame-retardant materials.

In a further non-limiting embodiment of any of the foregoing ventilation assemblies, each battery cell has independent first and second isolation layers.

In a further non-limiting embodiment of any of the foregoing ventilation assemblies, the battery pack has integral first and second isolation layers, and the first isolation layer and the second isolation layer extend along the entire inner surface of a top surface of the housing.

In a further non-limiting embodiment of any of the foregoing ventilation assemblies, the housing includes at least two battery modules, and each battery module includes an independent second isolation layers and a first isolation layer shared by the at least two battery modules.

A battery pack according to an exemplary aspect of the present disclosure includes, among other things, a battery pack housing, a plurality of battery modules including a plurality of battery cells arranged within the battery pack housing, and isolation layers located between the battery pack housing and the plurality of battery modules. Further, the isolation layers are made of a flame-retardant materials, and the isolation layers include a weakened area which is configured to at least partially separate from a remainder of the isolation layers under a first predetermined pressure.

In a further non-limiting embodiment of the foregoing battery pack, the isolation layers include a first isolation layer and a second isolation layer that are connected to each other in a connection area by a connecting component, areas other than the connection area in the first isolation layer and the second isolation layer are spaced apart by a first gap, the first isolation layer is closer to the battery pack housing, and the second isolation layer includes the weakened area.

In a further non-limiting embodiment of any of the foregoing battery packs, the battery module includes a module housing, the module housing includes a module exhaust port that allows fluid to pass through.

In a further non-limiting embodiment of any of the foregoing battery packs, the module exhaust port faces an outer periphery of the battery pack.

In a further non-limiting embodiment of any of the foregoing battery packs, the battery pack housing includes a fluid channel surrounding the outer periphery of the battery pack and a battery vent valve in communication with both the fluid channel and an area outside the battery pack housing, the module exhaust port is in communication with both the fluid channel and the first gap, and the vent valve is located at an end of the battery pack housing away from a front of a vehicle.

In a further non-limiting embodiment of any of the foregoing battery packs, the housing includes an auxiliary exhaust port, the auxiliary exhaust port is in communication with an auxiliary exhaust channel, and the auxiliary exhaust channel is further in fluid communication with a battery pack vent valve.

In a further non-limiting embodiment of any of the foregoing battery packs, the battery pack includes at least two battery modules arranged along a transverse direction of a vehicle, and the auxiliary exhaust ports of the two battery modules are arranged oppositely and spaced apart by the auxiliary exhaust channel that is in fluid communication with the auxiliary exhaust port of the battery modules.

### BRIEF DESCRIPTION OF THE DRAWINGS

FIG. 1 shows an electrified vehicle to which the battery pack of the present disclosure can be applied.

FIG. 2 shows the battery pack 100 that can be incorporated into an electrified vehicle according to a first embodiment, wherein the battery pack 100 is in a first state.

FIG. 3 shows the battery pack 100 that can be incorporated into an electrified vehicle according to the first embodiment, wherein the battery pack 100 is in a second state.

FIG. 4 shows a perspective view of a battery pack 200 that can be incorporated into an electrified vehicle according to another embodiment.

FIG. 5 shows a schematic diagram of the internal three-dimensional structure of battery pack 200 that can be incorporated into an electrified vehicle according to another embodiment, wherein the cover is removed.

FIG. 6 shows a partially exploded schematic diagram of the battery module in FIG. 5 according to another embodiment.

FIG. 7A shows a schematic diagram of the first isolation layer in an embodiment of the present disclosure.

FIG. 7B shows a schematic diagram of one side of the second isolation layer in an embodiment of the present disclosure.

FIG. 7C shows a schematic diagram of the other side of the second isolation layer in an embodiment of the present disclosure.

FIG. 8 shows an enlarged schematic diagram of a partial cross-section of the battery module in FIG. 5 along C-C.

FIG. 9 shows the configuration of an auxiliary fluid channel that can be used in the battery pack in the embodiment of FIG. 5.

### DETAILED DESCRIPTION

A ventilation assembly for a battery pack according to an aspect of the present disclosure includes, a housing accommodating a plurality of battery cells, and a first isolation layer and a second isolation layer that are at least partially spaced apart in the housing. Further, the first isolation layer is closer to the housing than the second isolation layer, and the second isolation layer includes a weakened area which is rupturable under a first predetermined pressure.

In one embodiment, the first isolation layer includes a first body portion and the second isolation layer includes a second body portion. The first body portion and the second body portion are connected to each other by a connecting component to form a connection area, and areas other than the connection area in the first body portion and the second body portion are spaced apart by a first gap.

In another embodiment, the weakened area and the connection area are offset from each other.

In yet another embodiment, the connecting component is formed integrally with at least one of the first body portion and the second body portion, and the connecting component is connected to the other one by one or more of welding, bonding, and fastener connection.

In another embodiment, the housing includes a predetermined fluid channel and a battery vent valve in communication with both the predetermined fluid channel and outside. The first gap is in communication with the predetermined fluid channel.

In yet another embodiment, the weakened area is configured to correspond to a cell exhaust valve of the battery cell.

In yet another embodiment, the battery cell has a cell exhaust valve, and the shortest distance between the second isolation layer and the cell exhaust valve is greater than the first gap.

In yet another embodiment, the weakened area includes continuous or discontinuous thinned and/or notched areas.

In another embodiment, the first isolation layer has a thickness greater than that of the second isolation layer, and both the first isolation layer and the second isolation layer are made of flame-retardant materials.

In yet another embodiment, each battery cell has independent first and second isolation layers.

In yet another embodiment, the battery pack has integral first and second isolation layers, and the first isolation layer and the second isolation layer extend along the entire inner surface of a top surface of the housing.

In another embodiment, the housing may include at least two battery modules composed of battery cells, and each battery module includes an independent second isolation layer and a first isolation layer which is independent or shared by at least two battery modules.

A battery pack according to another aspect of the present disclosure includes, a plurality of battery modules each including a plurality of battery cells, a battery pack housing accommodating the plurality of battery modules, and isolation layers located between the battery pack housing and the plurality of battery modules. Further, the isolation layers are made of a flame-retardant materials, and the isolation layers include a weakened area which is rupturable under a first predetermined pressure.

In one embodiment, the isolation layers include a first isolation layer and a second isolation layer that are connected to each other in a connection area by a connecting component. Further, areas other than the connection area in the first isolation layer and the second isolation layer are spaced apart by a first gap, the first isolation layer is closer to the battery pack housing, and the second isolation layer includes the weakened area.

In another embodiment, the battery module includes a module housing, and the module housing includes a module exhaust port that allows fluid to pass through.

In yet another embodiment, the module exhaust port faces an outer periphery of the battery pack.

In yet another embodiment, each battery cell has independent first and second isolation layers.

In yet another embodiment, the battery pack has integral first and second isolation layers, and the first isolation layer and the second isolation layer extend along the entire inner surface of a top surface of the housing.

In another embodiment, the housing may include at least two battery modules composed of battery cells, and each battery module includes an independent second isolation layer and a first isolation layer which is independent or shared by at least two battery modules.

In another embodiment, the battery pack housing includes a fluid channel surrounding the outer periphery of the battery pack, and a battery vent valve that is in communication with both the fluid channel and outside. Further, the module exhaust port is in communication with both the fluid channel and the first gap, and the vent valve is located at an end of the battery pack housing away from the front of the vehicle. In a specific embodiment, the vent valve of the battery pack faces generally the rear of the vehicle, behind the rear wheels.

In yet another embodiment, the module housing includes an auxiliary exhaust port, and the auxiliary exhaust port is in communication with an auxiliary exhaust channel, and the auxiliary exhaust channel is further in fluid communication with the battery pack vent valve.

In yet another embodiment, the battery pack includes at least two battery modules arranged along a transverse direction of the vehicle, and the auxiliary exhaust ports of the two battery modules are arranged oppositely and spaced apart by the auxiliary exhaust channel that is in fluid communication with the auxiliary exhaust port of the battery modules.

A vehicle according to another aspect of the present disclosure includes the battery pack in any one of the above-mentioned embodiments.

The above-mentioned advantages and other advantages and features of the present disclosure would become apparent upon reading the following specific embodiments alone or in conjunction with the drawings.

For the reference numbers in the drawings, the same or similar reference numbers are used to indicate the same or similar components. In the following description, multiple operating parameters and components are described in multiple embodiments. These specific parameters and components are only included as examples and are not meant to be limiting.

The disclosed battery pack ventilation system enhances structural strength and improves ventilation performance.

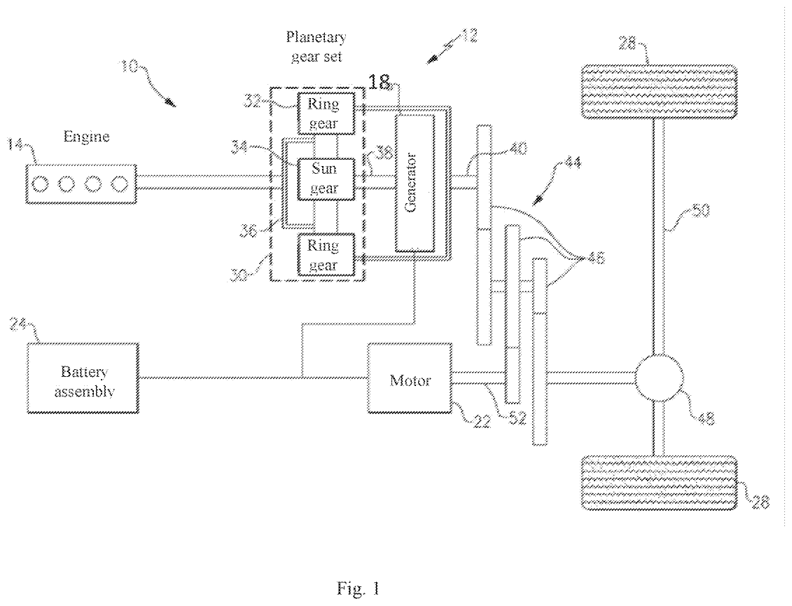

Referring to FIG. 1, an example of an electrified vehicle 12 to which the battery pack of the present disclosure can be applied is shown. Although depicted as a hybrid electric vehicle (HEV), it should be understood that the battery pack of this disclosure can be used in other types of deep hybrid plug-in electrified vehicles (PHEV), battery electrified vehicles (BEV), full hybrid electrified vehicles (FHEV), etc.

In one embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), a generator 18 and a battery assembly. In this example, the second drive system is considered an electric drive system of the powertrain 10. The first and second drive systems generate torque to drive one or more sets of vehicle drive wheels 28 of the electrified vehicle 12. Although in this illustrative embodiment, a power-split configuration is shown, the disclosure extends to any hybrid electrified vehicle including full hybrids, parallel hybrids, series hybrids, mild hybrids, and micro hybrids. The engine 14 and the generator 18 may be connected through a power transfer unit 30. In addition to planetary gear sets, other types of power transfer units may also be used to connect the engine 14 to the generator 18. In a non-limiting example, the planetary gear set includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Since the generator 18 is operatively connected to the engine 14, the speed of the engine 14 can be controlled by the generator 18.

The ring gear 32 of the power transfer unit 30 is connected to a shaft 40, which is connected to the vehicle drive wheels 28 through a second power transfer unit 44. The second power transfer unit 44 may include a gear set having a plurality of gears 46. Other power transfer units could be used in other examples. The gears 46 transfer torque from the engine 20 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The battery assembly 24 is an example type of an electrified vehicle battery assembly. The battery assembly 24 can provide power to drive the motor. In regenerative braking, the motor 22 and the generator 18 can output power to the battery assembly 24 for storage. The battery assembly 24 may include a high-voltage battery pack, which may include multiple battery arrays. In the following embodiments, a battery pack that can be incorporated into the above-mentioned example electrified vehicle is provided.

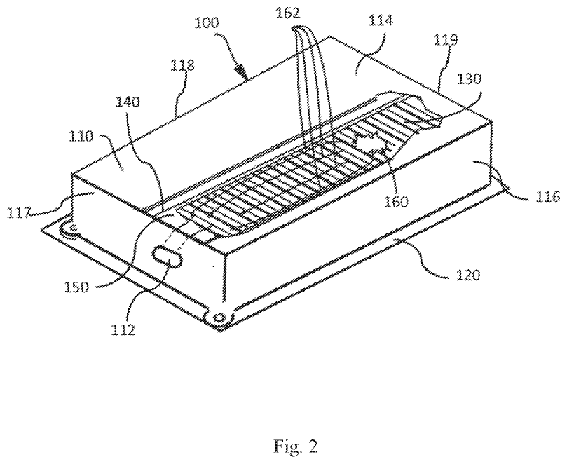

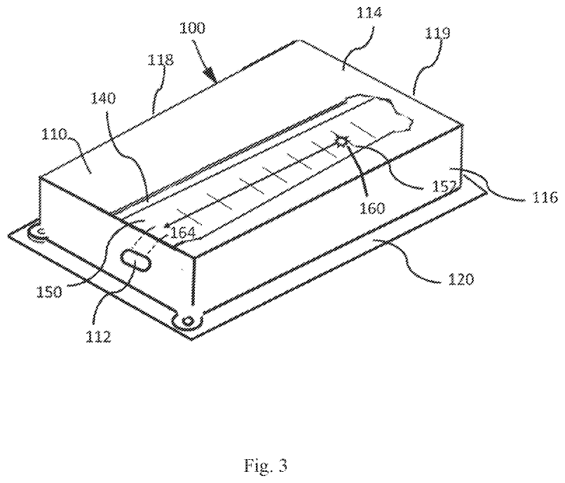

FIGS. 2 and 3 show the battery pack 100 that can be incorporated into an electrified vehicle according to a first embodiment. For example, the battery pack 100 can be used in the battery assembly 24. The number and types of battery cells included in the battery pack 100 can be changed according to needs. Multiple battery cells (or battery units) can form a single array or multiple battery arrays, and the battery arrays can further form a battery module in the form of a certain division and combination, or a battery array itself can also be used as a battery module. The distinction between these terms is only for the convenience of description of the embodiments in the present disclosure, and is not intended to be limiting.

In the illustrative embodiment of FIGS. 2 and 3, the battery pack 100 may include a housing 110, a tray 120, and a plurality of battery cells 130 arranged between the housing 110 and the tray 120. The housing 110 has a top surface 114, a first side 116, a second side 117, a third side 118, and a fourth side 119. The tray 120 and the housing 110 can be connected to form a space to close the battery cells 130. In one embodiment, the space formed by the housing 110 and the tray 120 is an enclosed space, and except for a pre-set vent valve 112, the remainder of the space is fluid-tight. Those skilled in the art can understand that the design of the tray 120 and the housing 110 may have different forms. For example, in another embodiment, the housing 110 has a top and the tray 120 has a bottom surface and sides. Or in another embodiment, the housing 110 and the tray 120 each has side parts and form a connection on the sides, which should be included in the scope of the present disclosure. In addition, it can be understood that the battery cell 130 may adopt any suitable battery of chemical composition, including but not limited to various types of lithium batteries already on the market. The shape of the specific battery cell 130 can be various, including prismatic batteries, square batteries, or cylindrical batteries, etc.

With continued reference to FIGS. 2 and 3, the housing 110 further includes the aforementioned vent valve 112 that is in fluid communication with the outside. The vent valve 112 may be of any suitable type, and one battery pack 100 may also include a suitable number of vent valves 112. One type of vent valve 112 can refer to CN105280981A, the entirety of which is herein incorporated by reference. In other embodiments, the vent valve 112 may be a two-way vent valve, so as to maintain a reasonable pressure balance between the inside and outside of the battery pack housing, and avoid the accumulation of negative pressure or overpressure in the battery pack housing. In the described non-limiting example, the battery pack 100 further includes a first isolation layer 140 and a second isolation layer 150 between the housing 110 and the battery cell 130. The second isolation layer 150 includes a weakened area 152 that is rupturable and would be broken, meaning that it is configured to at least partially separate from the remainder of the second isolation layer 150, under the first predetermined pressure. The weakened area may be referred to as an intentionally weakened area, or a frangible section, as the weakened area is intentionally designed be rupturable under certain conditions, as explained in this disclosure. As shown in the figure, when a slight gas release event occurs in a certain battery cell 130, as indicated by the reference 160, under the first predetermined pressure, the gas can escape from the battery pack vent valve 112 in the direction shown by the arrow 162.

FIG. 3 shows another situation when a gas release event occurs in a certain battery cell 130 in the above embodiment. When a certain battery cell is exhausted, causing the local instantaneous air pressure to exceed the first predetermined pressure, the predetermined weakened area 152 of the second isolation layer 150 can be ruptured and opened, so that at least part of the gas escapes from the second isolation layer 150, and then flows away from the gap between the first isolation layer 140 and the second isolation layer 150, as shown by the arrow 164, and finally overflow from the battery vent valve 112. The first predetermined pressure can be changed according to the battery structure, the electrochemical properties of the cathode, the anode, and the electrolyte, and the design requirements. In the above non-limiting embodiment, the first isolation layer 140 and the second isolation layer 150 are shown as an integral type, extending along the inner surface of the top surface 114 of the housing 110 of the battery pack 100. Extending along the inner surface may mean that the first isolation layer 140 and the second isolation layer 150 extend generally along the entire inner surface of the entire top surface 114 of the housing 110. In another embodiment, the first isolation layer 140 and the second isolation layer 150 further have sidewall portions extending at least partially to the sides 116, 117, 118 and 119. In yet another embodiment, the first isolation layer 140 and the second isolation layer 150 have a top, sides, and a bottom that are adapted to the space formed by the housing 110 and the tray 120, so that the entire battery modules or battery arrays composed of the battery cells 132 are wrapped. Of course, appropriate exhaust channels or openings should be reserved. In another embodiment, each battery cell 132 may include one isolation layer or two isolation layers. In another embodiment, it can be understood that the integral design is not necessary, and an independent isolation layer design described in the following embodiment can be formed for each battery module.

In the embodiment shown in FIGS. 2 and 3, the first isolation layer 140 and the second isolation layer 150 are provided, and they can be connected to each other in a suitable manner, such as but not limited to through fasteners, adhesives, welding, etc., to form an integrated isolation layer assembly. There may be a gap between the first isolation layer 140 and the second isolation layer 150. In other words, there is a gap at least in areas where no connection is formed. In another embodiment, only one isolation layer may be provided. In one or more embodiments, the material of the isolation layer is a flame-retardant material, such as but not limited to mica, glass fiber, and the like. In some embodiments, the insulation layer material has a temperature resistance of more than 1200° C., a flame-retardant grade of V0, and a pressure resistance of 800KP to 1000KP. The first isolation layer 140 generally has a thickness thicker than that of the second isolation layer 150. For example, the thickness of the first isolation layer 140 may be 1-4 mm, and specifically, in one embodiment, it may be approximately 2 mm-3 mm. The thickness of the second isolation layer 150 may be 0.3-1 mm, and in a specific embodiment, it may be 0.5 mm-0.8 mm. In one embodiment, the isolation layer contains mica material, referring to the above-mentioned parameters that can withstand high temperature and impact. It can be understood that, depending on the type of flame-retardant material, structural strength, layout space, etc., a thinner or thicker first isolation layer and/or second isolation layer may also be provided.

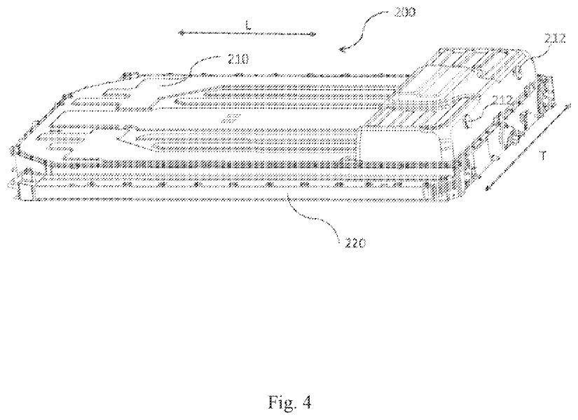

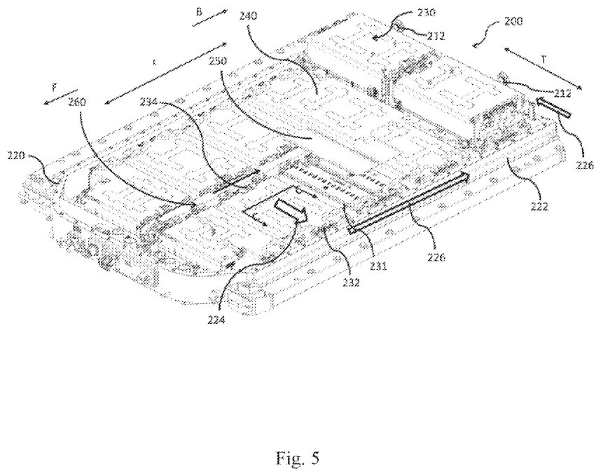

FIGS. 4 and 5 show a battery pack 200 that can be incorporated into an electrified vehicle according to another embodiment. The battery pack 200 generally includes a cover 210, a tray 220 and a plurality of battery cells 231. The cover 210 and the tray 220 are connected to each other to form a cavity for accommodating the battery cells 231. A pair of vent valves 212 can also be formed on the cover 210. It can be understood that the vent valve 212 may also be provided on the tray 220. As described above, the cavity may be fluid-tight except the predetermined vent valve 212. In order to facilitate the description of this disclosure and for the sake of brevity, the battery management unit, wiring harness, cooling and other systems are omitted here without too much discussion. FIG. 5 further shows a schematic diagram of the battery pack 200 with the cover 210 opened. In this non-limiting embodiment, the battery pack 200 includes a battery module 230 composed of a plurality of battery cells, and the battery module 230 are generally arranged in two columns along a vehicle width direction T, thereby forming a space 240 in the middle. Each column of the battery module 230 extends along a longitudinal direction L of the vehicle. It can be understood that there can be many kinds of battery arrays, depending on battery performance, battery cell size, battery module structure, etc., one column, two columns and more columns of the battery module can be arranged.

In the non-limiting embodiment shown in FIGS. 4 and 5, the battery module 230 includes module exhaust ports 232, and these exhaust ports 232 generally face an outer periphery of the battery pack 200. Depending on how the battery modules 230 are assembled into a battery pack, the position of the exhaust port 232 can be adjusted adaptively. Generally, in the described embodiment, when the battery cell 231 generates exhaust gas, most of the released gas flows through the module exhaust port 232 of the battery module 230 to the peripheral fluid channel 222 surrounding the battery pack 200, and the way of gas flow is shown by arrows 224 and 226. The exhaust gas is released along 232 of the battery module, and flows along the outer periphery of the battery pack 200 to the exhaust valve 212, and is released through the exhaust valve 212. In this embodiment, the exhaust valve 212 is configured to be two-way air-permeable, but has the function of preventing the ingress of water into the battery pack. In a further embodiment, a central auxiliary fluid channel 260 is further provided in the gap between the two battery modules 230. The module 230 and the auxiliary fluid channel 260 may be in fluid communication with the auxiliary exhaust port 234. Of course, it can be understood that the auxiliary exhaust port 234 is not necessary, and the exhaust gas can be released only through the exhaust port 232 at one end through end sealing.

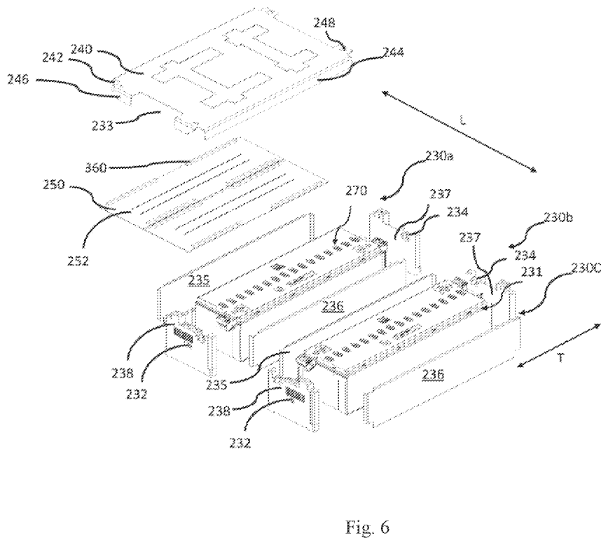

FIG. 6 shows an exploded schematic diagram of a specific battery module 230 structure. As shown in the figure, the battery module 230 includes arrays 230a, 230b formed by a plurality of battery cells 231. The battery module 230 may include a module housing 230C surrounding the battery cells. A module exhaust port 232 is formed on the module housing 230C. In an embodiment, the module housing may be cast integrally, or may be formed into multiple parts connected by fasteners or welding. Depending on the shape and arrangement of the battery cells themselves, the module housing 230C has an adaptive configuration. For example, the module housing 230C may be square, prismatic, cylindrical, or the like. In the described embodiment, it can be seen that the arranged battery cells 231 have a substantially rectangular parallelepiped shape, including a bottom surface, a top surface, and first, second, third, and fourth sides extending between the bottom surface and the bottom surface. The battery module 230 may be supported on the tray 220 shown in FIGS. 4 and 5, and the module housing 230C may further include first and second side partitions 235, 236 and first and second end partitions 237,238 for fixing and accommodating the battery array. The first and second side partitions are opposed to each other along the longitudinal direction L of the vehicle, and the first end partition 237 and the second end partition 238 are opposed along the vehicle width direction. The battery module exhaust port 232 facing the outer periphery of the battery pack may be formed on the second end partition 238. The airflow can flow into the aforementioned fluid channel 222 through the exhaust port 232. Further, the above-mentioned auxiliary exhaust port 234 can be formed on the first end surface partition 237, wherein the air flow can assist the central auxiliary fluid channel 260 through the auxiliary exhaust port 234. Of course, it can be understood that the auxiliary exhaust port is not necessary, and the airflow can only flow out through the exhaust port 232 by sealing one end 237.

Referring to FIG. 6 in conjunction with FIGS. 4 and 5, the battery module 230 includes two battery arrays 230a and 230b, and further includes a first isolation layer 240 covering the entire top surface of the battery module 230 and second isolation layers 250 covering the battery array 230a and the battery array 230b separately. It can be understood that such an arrangement is only for illustration and not for limitation. Those skilled in the art can choose to set the first isolation layer and the second isolation layer separately for each battery array, or they can choose to set the first isolation layer and the second isolation layer to cover multiple battery arrays. In the illustrated embodiment, the isolation layer 240 includes a main body region extending along the top surface of the battery module 230, a first side portion 242 and a second side portion 244 extending to the first side 235 and the second side 236 of the battery module, and a first end portion 246 and a second end portion 248 at least partially covers the first end surface 237 and the second end surface 238. Although in the illustrated embodiment, the first side portion 242, the second side portion 244, the first end portion 246, and the second end portion 248 are formed as a flanging structure, it can be understood that the length of the flanging shown in the figure is only for illustrative purpose, those skilled in the art can make changes according to actual needs. When the flanging is long enough to touch the tray, it can be fixed to the tray by a variety of suitable connection methods such as fasteners, bonding, welding, etc.

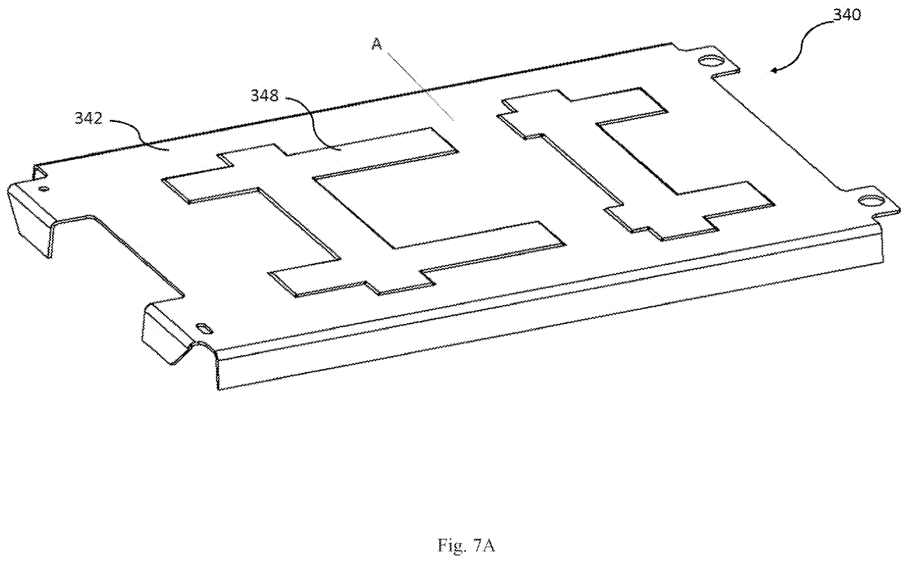

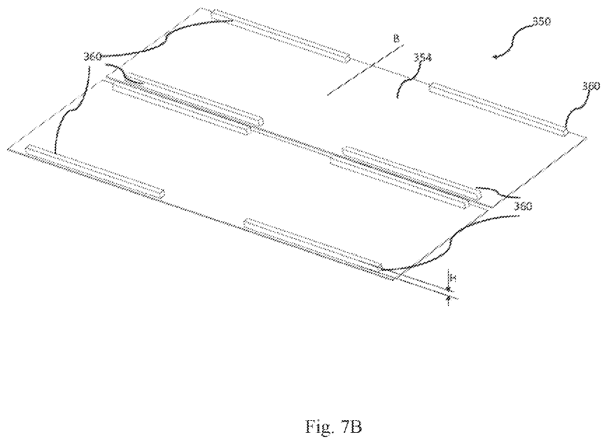

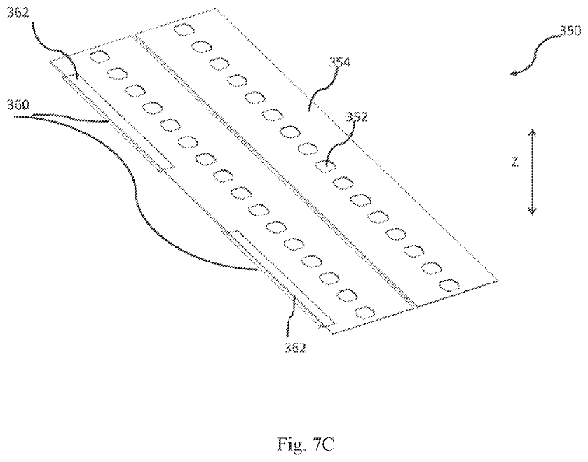

Continuing to refer to FIG. 6, in this illustrative embodiment, the first isolation layer 240 is connected to the module housing or partition of the battery module 230 such as partition 235, 236, 237, 238. Wherein, the first end potion 246 of the first isolation layer 240 includes an opening 233 that allows fluid to pass through, which corresponds to the module exhaust port 232. In other words, the first end 246 is configured to allow the gas flow of the module exhaust port 232. Between the first isolation layer 240 and the battery cell 231, a second isolation layer 250 is further included. There is a first gap between the first isolation layer 240 and the second isolation layer 250, which will be described in detail below with reference to the drawings. The second isolation layer 250 includes one or more weakened areas 252. The dotted line in FIG. 6 generally shows the location of the weakened areas 252, which may be on the side of the second isolation layer 250 facing the battery cell 231. The dotted area is only for illustration and does not represent a specific shape, and the specific implementation shown in FIG. 7C can be shown below. The weakened area 252 may correspond to the cell exhaust valve 270 of the battery cell 231. For example, the weakened area 252 may be formed as a thinned area corresponding to the cell exhaust valve 270, or the weakened area 252 may have a notch around the cell exhaust valve 270. The cell exhaust valve 270 shown in the figure is located on the integrated battery cell cover. In other words, multiple battery cells share a battery cover, and multiple unit exhaust valves 270 corresponding to each battery cell 231 are formed on the entire battery cover. Of course, those skilled in the art can understand that each battery cell can have an independent cover and exhaust valve 270. The so-called thinned area is an area formed into a relatively small thickness, or an area where a part of the thickness of the material is removed. The notch may refer to the formation of a weakened area by cutting at a certain depth discontinuously. The cutting may or may not penetrate the second isolation layer. The cutting shape can be various, such as but not limited to discontinuous punching, dotting, and lines. The weakened area here or elsewhere in the disclosure may refer to a predetermined area that is easier to rupture than other areas under the first predetermined pressure. In one or more embodiments, the first predetermined pressure is 1 MPa. Those skilled in the art can set a lower or higher predetermined pressure according to requirements and the electrochemical performance of the battery.

In the above-mentioned embodiments, the module housing 230C is substantially fluid-tight, except for the predetermined module vents such as 232 and the auxiliary exhaust 234 in some embodiments. When an exhaust event occurs in a certain battery cell 231, if the instantaneous air pressure of the exhaust gas is lower than a first predetermined pressure, the exhaust gas of the battery cell 231 will be released to the fluid channel 260 such as described in the above embodiment through the module exhaust port 232. When the instantaneous air pressure of the exhaust reaches the first predetermined pressure, the weakened area 252 of the second isolation layer 250 is opened by the air pressure, so that a part of the gas passes through the opened weakened area 252 and enters into the first gap between the first isolation layer 240 and the second isolation layer 250. This instantaneous exhaust is temporarily divided into the part between the first isolation layer 240 and the second isolation layer 250, that is, the first gap part, and the part between the second isolation layer 250 and the battery cell 231. The amount of air and oxygen in these two parts are limited, which further reduces the tendency of instantaneous exhaust to mix with air. The gas will then gradually exit the battery exhaust valve 212 through the module exhaust port 232 and the fluid channel 260.

The isolation layer structure that can be used in the above embodiment is further described with reference to FIGS. 7A to 7C. The schematic configuration of the first isolation layer 340 and the second isolation layer 350 are specifically shown. In this illustrative embodiment, the first isolation layer 340 has a thickness greater than that of the second isolation layer 350, and the similar second isolation layer 350 has a weakened area 352 corresponding to the battery cell such as 231 above. It can be seen that the weakened area 352 is slightly different from the weakened area 252 in the above embodiment. In this embodiment, there are multiple weakened areas 352, which are independent of each other, and can respectively correspond to the exhaust valves of each battery cell. The first isolation layer 340 includes a first body portion 342 extending generally along a first plane A, and the first plane A may be substantially parallel to the top surface of the battery module 230 in the above-mentioned embodiment. The second isolation layer 350 includes a second body portion 354 extending generally along a second plane B, and the second plane B may be substantially parallel to the first plane A. The first main body portion 342 and the second main body portion 354 are connected to each other by a connecting component 360 shown in the figure to form a connection area, and areas other than the connection area in the first body portion 342 and the second body portion 354 are spaced apart by the first gap. In one embodiment, the first gap may correspond to a thickness H of the connecting component 360. Of course, it can be understood that in other embodiments, the first main body portion 342 and the second main body portion 354 may have other shapes, and may have designs such as protrusions and depressions, and the thickness of the connecting component 360 may not completely correspond to the first gap.

With continued reference to FIGS. 7A-7C in conjunction with FIGS. 1 to 6, in one or more embodiments, the connecting components 360 can be formed integrally with the first or second isolation layer, and then connected to the other isolation layer by one or more of bonding, fasteners, welding, etc. The first isolation layer 340 and the second isolation layer 350 are connected to each other to obtain more rigid after connection, but there is a gap in the non-connected area between the first isolation layer and the second isolation layer so that the concentrated exhaust air flow can be divided, and the amount of air that may be instantaneously mixed with exhaust can be reduced. In another embodiment, the first isolation layer 340 and the second isolation layer 350 may be connected by independent connecting components 360. In yet another embodiment, the first isolation layer and the second isolation layer may be formed as an integral but hollow structure, and have a similar weakened area as described above and a relative gap for shunting. In the above embodiment, the weakened area 352 and the connection area 362 are relatively offset. Although two connecting areas 362 are marked in the figure, it can be understood that all areas corresponding to the connecting member 360 may be connecting areas. In other words, the weakened area 352 and the connecting area 362 do not overlap each other, and are offset in a longitudinal Z direction, so that the opening of the weakened area 352 is not hindered. In addition, in one or more embodiments, the first isolation layer 340 may also have reinforcing ribs 348 structure. There can be one reinforcing rib 348 or more than one more reinforcing ribs 348, and the reinforcing ribs 348 can be arranged in a crisscross pattern. The reinforcing ribs 348 may also correspond to the weakened areas 352 of the second isolation layer 350 to provide greater structural strength to areas where the gas may further impact the first isolation layer. It can be understood that the connecting component 360 or the connection area 362 can be arranged as required, but the exhaust gas in the first gap cannot be prevented from being discharged to the module exhaust port and the battery fluid channel.

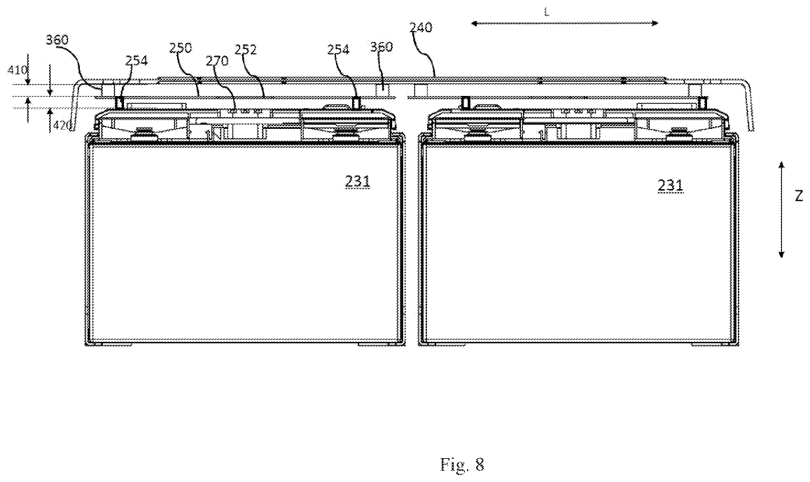

FIG. 8 shows a schematic cross-sectional view of one of the battery modules 230 in FIG. 5 along the line C-C. In the illustrated embodiment, for the purpose of simplification, only the reference numerals of the battery module on one side are marked, and it is understood that the battery module on the other side may also have a similar structure. Wherein, the battery cell 231 includes a cell exhaust valve 270, and the second isolation layer 250 includes a weakened area 252 corresponding to the cell exhaust valve 270. The second isolation layer is separated from the battery cell 231 by a second gap through one or more supporting portions 254 contacting the battery cell 231. It can be understood that the supporting portion 254 may not be provided, and the adjustment of the relative gap can be achieved by the integration of the second isolation layer 250 and the first isolation layer 240, and the connection between the first isolation layer 240 and the housing. As shown in the figure, the first gap 410 is defined as the gap between the first isolation layer 240 and the second isolation layer 250. The second gap 420 is the shortest distance between the second isolation layer 250 and the cell exhaust valve 270, or the distance along the Z direction. In this detailed embodiment, the second gap 420 is larger than the first gap 410. If the first isolation layer/second isolation layer further has irregular shapes such as depressions and protrusions, the first gap and the second gap may refer to the average gap or the shortest gap. In other embodiments, the size of the first gap and the second gap refer to the size of the space between them that can contain air and mixed gas. In some embodiments, the size of the first gap is generally 1-4 mm, and the size of the second gap is generally 5-15 mm. In other embodiments, the size of the first gap is generally 2-3 mm, and the size of the second gap is generally 8-15 mm. When the first gap and the second gap have different ranges, the average gap size may be within the aforementioned interval. Of course, in another embodiment, except for the connection position, The maximum size and minimum size of the first gap are both in the range of 1-4 mm, and the maximum size and minimum size of the second gap are both in the range of 5-15 mm.

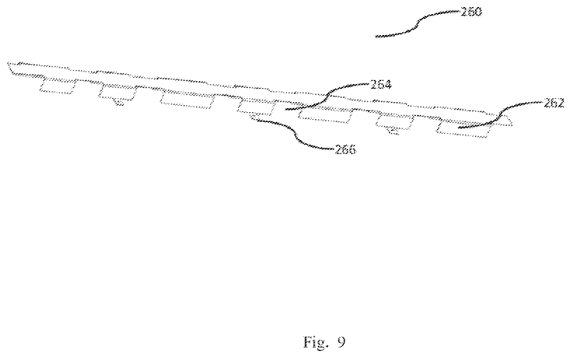

FIG. 9 shows the configuration of the auxiliary fluid channel 260 that can be used in the battery pack in the embodiment of FIG. 5. Referring to FIG. 9 in conjunction with FIG. 5, in one embodiment, the auxiliary fluid channel 260 may have a material structure similar to the first isolation layer and the second isolation layer, for example, it may be a flame-retardant material, including glass fiber, mica, etc. In this embodiment, the auxiliary fluid channel 260 is configured as a rectangular hollow structure and forms a fluid channel space with the tray 220. It can be understood that it can have any suitable cross-sectional shape. For example, in some embodiments, the auxiliary fluid channel 260 can have any suitable shape such as a circle, an ellipse, a rectangle, a direction, a diamond, etc., which itself can define a pipe through which fluid passes, without combining with the tray. The auxiliary fluid channel 260 may include side wall parts 262, and the side wall parts 262 may be multiple and define openings 264 therebetween. The openings 264 are in communication with the exhaust port of the battery module 230. At least a portion of the side wall portion 262 may also include a lug 266 extending and connecting to the tray. The auxiliary fluid channel 260 may be fixedly connected to the battery tray 220 by a fastener (not shown). The tray 220 can also be connected to the tray 220 by other suitable bonding, welding, or the like. In one or more embodiments, the battery pack further includes other pipes such as a wire harness that is not shown, and these wire harnesses or pipes may be located in the auxiliary fluid channel 260 for protection. In another embodiment, these wire harnesses or pipes may be supported on the auxiliary fluid channel 260.

One or more of the above embodiments provide some specific implementations of the battery pack. This disclosure also provides a vehicle including the battery pack in the above embodiment. Specifically, the vehicle may include a battery pack arranged at any suitable position. For example, the battery pack can be distributed but not limited to suitable areas such as the vehicle chassis, under the seat, trunk, and under the hood. Wherein the battery pack includes a battery pack housing and a plurality of battery cells located in the housing. Wherein the housing may include a fluid channel surrounding the outer periphery of the battery pack, and a battery pack vent valve communicating with both the fluid channel and outside. The battery pack vent valve can be used to release the exhaust gas in the battery, and in some embodiments, to maintain air pressure balance, such as balancing the negative pressure generated in the battery pack. The housing further includes isolation layers between the battery cell and the housing. The isolation layers may be made of a flame-retardant material, and may include first and second isolation layers forming a gap between each other and connecting to each other. A first gap is defined between the first and second isolation layers. On the one hand, such hollow connection can play a role in strengthening the structure; and on the other hand, it can play a role in dispersing instantaneous exhaust and dispersing the total amount of air contact. When the battery cells are combined into arrays or battery modules, each battery array or battery module may have an independent module exhaust port and independent first and second isolation layers. In one or more embodiments, the module exhaust port is in communication with the above-mentioned first gap and the fluid channel, so that the exhaust gas in the first gap can enter the peripheral fluid channel of the battery through the exhaust port, and further be exhausted from the battery pack vent valve. The aforementioned vent valve may be located at an end of the battery pack housing away from the front of the vehicle. For example, in one embodiment, the vent valve is generally oriented toward the rear of the vehicle, such as near the rear of the rear wheel. Of course, an auxiliary fluid channel can also be provided for guiding the exhaust gas to the vent valve.

One or more of the above-mentioned embodiments provide a battery pack isolation assembly and a vehicle including such a battery pack. Those skilled in the art can make various changes, modifications and changes to these specific embodiments without departing from the essence and scope defined by the claims of this disclosure.

Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A ventilation assembly for a battery pack, comprising:
a housing;
a plurality of battery cells arranged in the housing; and
a first isolation layer and a second isolation layer at least partially spaced-apart from one another and arranged in the housing, wherein the first isolation layer is closer to the housing than the second isolation layer, and wherein the second isolation layer at least includes a weakened area configured to at least partially separate from a remainder of the second isolation layer under a first predetermined pressure.

2. The ventilation assembly of claim 1, wherein the first isolation layer includes a first body portion, the second isolation layer includes a second body portion, the first body portion and the second body portion are connected to each other by a connecting component to form a connection area, and areas other than the connection area in the first body portion and the second body portion are spaced apart by a first gap.

3. The ventilation assembly of claim 2, wherein the weakened area and the connection area are offset from each other.

4. The ventilation assembly of claim 2, wherein the connecting component is formed integrally with at least one of the first body portion and the second body portion, and connected to the other of the first body portion and the second body portion by one or more of welding, bonding, and a fastener.

5. The ventilation assembly of claim 2, wherein the housing includes a predetermined fluid channel and a battery pack vent valve in communication with both the predetermined fluid channel and an area outside the housing, wherein the first gap is in communication with the predetermined fluid channel.

6. The ventilation assembly of claim 5, wherein the battery cell includes a cell exhaust valve, and the weakened area is configured to correspond to the cell exhaust valve of the battery cell.

7. The ventilation assembly of claim 6, wherein the shortest distance between the second isolation layer and the cell exhaust valve is greater than the first gap.

8. The ventilation assembly of claim 1, wherein the weakened area includes one of a thinned area and a notched area.

9. The ventilation assembly of claim 8, wherein the weakened area is continuous or discontinuous.

10. The ventilation assembly of claim 1, wherein the first isolation layer has a thickness greater than that of the second isolation layer, and wherein both the first isolation layer and the second isolation layer are made of flame-retardant materials.

11. The ventilation assembly of claim 1, wherein each battery cell has independent first and second isolation layers.

12. The ventilation assembly of claim 1, wherein the battery pack has integral first and second isolation layers, and the first isolation layer and the second isolation layer extend along the entire inner surface of a top surface of the housing.

13. The ventilation assembly of claim 1, wherein the housing includes at least two battery modules, and each battery module includes an independent second isolation layers and a first isolation layer shared by the at least two battery modules.

14. A battery pack, comprising:
a battery pack housing;
a plurality of battery modules including a plurality of battery cells arranged within the battery pack housing; and
isolation layers located between the battery pack housing and the plurality of battery modules, wherein the isolation layers are made of a flame-retardant materials, and wherein the isolation layers include a weakened area which is configured to at least partially separate from a remainder of the isolation layers under a first predetermined pressure.

15. The battery pack of claim 14, wherein the isolation layers include a first isolation layer and a second isolation layer that are connected to each other in a connection area by a connecting component, wherein areas other than the connection area in the first isolation layer and the second isolation layer are spaced apart by a first gap, wherein the first isolation layer is closer to the battery pack housing, and wherein the second isolation layer includes the weakened area.

16. The battery pack of claim 15, wherein the battery module includes a module housing, the module housing includes a module exhaust port that allows fluid to pass through.

17. The battery pack of claim 16, wherein the module exhaust port faces an outer periphery of the battery pack.

18. The battery pack of claim 17, wherein the battery pack housing includes a fluid channel surrounding the outer periphery of the battery pack and a battery vent valve in communication with both the fluid channel and an area outside the battery pack housing, wherein the module exhaust port is in communication with both the fluid channel and the first gap, wherein the vent valve is located at an end of the battery pack housing away from a front of a vehicle.

19. The battery pack of claim 18, wherein the housing includes an auxiliary exhaust port, the auxiliary exhaust port is in communication with an auxiliary exhaust channel, and the auxiliary exhaust channel is further in fluid communication with a battery pack vent valve.

20. The battery pack of claim 19, wherein the battery pack includes at least two battery modules arranged along a transverse direction of a vehicle, and the auxiliary exhaust ports of the two battery modules are arranged oppositely and spaced apart by the auxiliary exhaust channel that is in fluid communication with the auxiliary exhaust port of the battery modules.
